(19) United States
(12) Patent Application Publication
(10) Pub. No.: US 2026/0328992 A1
(43) Pub. Date: Oct. 22, 2026

(54) ANTI-RESONANT HOLLOW CORE OPTICAL FIBER WITH CONTACTING PRIMARY CAPILLARIES CONTAINING MULTIPLE AND SPACED NESTED CAPILLARIES

(71) Applicant: CORNING INCORPORATED, CORNING, NY (US)

(72) Inventors: Paulo Clovis Dainese, Jr., Painted Post, NY (US); Ilia Andreyevich Nikulin, Leland, NC (US)

(21) Appl. No.: 19/637,109

(22) Filed: Apr. 2, 2026

Related U.S. Application Data
(60) Provisional application No. 63/790,104, filed on Apr. 17, 2025.

(51) Int. Cl. G02B 6/02

(52) U.S. Cl. CPC G02B 6/02328; G02B 6/02357; G02B 6/02366; G02B 6/02371

(57) ABSTRACT

An anti-resonant hollow core optical fiber including: a cladding tube, a cladding inner surface at a cladding inner radius from a fiber longitudinal axis, the cladding inner radius varying azimuthally around the fiber longitudinal axis, the cladding inner surface defining recesses; a plurality of primary capillaries, each disposed within one of the recesses, and contacting the cladding inner surface and adjacent primary capillaries in both azimuthal directions; a plurality of first nested capillaries each disposed within a different one of the primary capillaries; a plurality of second nested capillaries disposed within the primary interior of a different one of the primary capillaries along with one of the first nested capillaries, a plurality of third nested capillaries each disposed within a different one of the first nested capillaries, and a plurality of fourth nested capillaries each disposed within a different one of the second nested capillaries.

This Application claims the benefit of priority to U.S. Provisional Patent Application Ser. No. 63/790,104 filed on Apr. 17, 2025, the content of which is relied upon and incorporated herein by reference in its entirety.

### TECHNICAL FIELD

The present disclosure pertains to anti-resonant hollow core optical fibers and, more particularly, to anti-resonant hollow core optical fibers that include anti-resonant cladding elements that (i) contact each other, (ii) are set within recesses of a cladding tube, and (iii) each of which contains a plurality of spaced apart multiply nested capillaries.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core and to prevent leakage of modes into the cladding. Those optical fibers are sometimes referred to as anti-resonant hollow core optical fibers, or AR-HCFs for short. With AR-HCFs, a central hollow core is surrounded by anti-resonant cladding elements contained in a cladding tube. The anti-resonant cladding elements can be made of relatively thin glass to realize an anti-resonant effect. Anti-resonance occurs when electromagnetic radiation within any of the anti-resonant cladding elements destructively interferes with itself, resulting in minimum transmission of optical power through the glass of the anti-resonant element. The greater the anti-resonant effect of the cladding elements, the greater the confinement of electromagnetic radiation within the core, and thus the lower the confinement loss.

Engineering and design of anti-resonant cladding elements to achieve better confinement loss across desirable wavelength ranges is an evolving field of endeavor. In addition, there is a practical problem in that AR-HCFs are difficult to manufacture at large scale. The anti-resonant cladding elements must satisfy exacting structural requirements to perform efficiently and are highly sensitive to dimensional fluctuations expected from manufacturing variability. For example, if anti-resonant cladding elements designed not to contact each other but do as a result of manufacturing imprecision, the anti-resonant hollow core optical fiber exhibits peaks in confinement loss as a function of wavelength. Further, inaccuracies in the azimuthal position of the anti-resonant cladding elements relative to each other impacts the confinement loss. Furthermore, it is difficult to manufacture the anti-resonant hollow core optical fiber where the anti-resonant cladding elements do not make contact and/or where the anti-resonant cladding elements are drawn in their as-designed azimuthal position. There is accordingly a need for new designs of hollow core optical fibers that provide greater stability in the dimensions and position of anti-resonant cladding elements.

### SUMMARY

The present disclosure addresses those problems, and others, with an anti-resonant hollow core optical fiber that includes a cladding tube with recesses within which anti-resonant cladding elements with primary capillaries are disposed and dimensioned so that adjacent primary capillaries contact each other. The anti-resonant hollow core optical fiber is designed to avoid sharp attenuation peaks in the attenuation spectrum despite contact of the primary capillaries The anti-resonant hollow core optical fiber becomes easier to manufacture because contact between adjacent primary capillaries stabilizes the structure and makes it less sensitive to variabilities in manufacturing. The recesses further stabilize the structure by preventing the primary capillaries from rotating or moving azimuthally relative to each other and the cladding tube during manufacture. The cladding tube, having an inner surface with recesses forming peaks extending toward a center of the cladding tube, fills in the space radially outward of the primary capillaries. The recesses are depressions that increase the distance of the inner surface of the cladding tube and the primary capillaries from the hollow core to mitigate leakage of the fundamental mode through the primary capillaries to the cladding tube thereby improving confinement of the fundamental mode.

Confinement is further improved by including a plurality of multiply nested capillaries within each of the primary capillaries. Each primary capillary contains at least two nested capillaries. The at least two nested capillaries are contained within the primary capillary and are spaced apart. Each of the at least two nested capillaries directly contacts an inner surface of the primary capillary. The outer surfaces of the at least two nested capillaries are not in direct contact with each other. At least one of the at least two nested capillaries further includes a nested capillary within its interior and is thus multiply nested. Preferably all nested capillaries with each of the primary capillaries is multiply nested. In a preferred embodiment each of the at least two nested capillaries in each primary capillary is a doubly nested capillary. Embodiments in which the nested capillaries of the primary capillary are triply nested, quadruply nested etc. are also envisioned.

Not only is manufacturing of the hollow core optical fiber easier with the designs described herein but performance is improved as the fundamental mode exhibits low confinement loss and a smooth attenuation spectrum. At the same time, confinement loss for higher order modes is relatively high, which is beneficial for achieving or approaching single mode transmission in a hollow core optical fiber.

According to a first aspect of the present disclosure, an anti-resonant hollow core optical fiber comprises:
a fiber longitudinal axis extending from a first fiber end to a second fiber end;
a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis, wherein the cladding inner radius is azimuthally variable around the fiber longitudinal axis and the cladding inner surface defines a plurality of recesses;
a plurality of primary capillaries arranged azimuthally around the fiber longitudinal axis, each of the plurality of primary capillaries (a) disposed within a different one of the plurality of recesses and contacting the cladding inner surface, (b) contacting or merging with an adjacent primary capillary in both azimuthal directions around the fiber longitudinal axis, and (c) comprising (i) a primary longitudinal axis that is parallel to the fiber longitudinal axis, (ii) a primary outer surface at a primary outer radius from the primary longitudinal axis, and (iii) a primary inner surface at a primary inner radius from the primary longitudinal axis, the primary inner surface defining a primary interior;
a plurality of first nested capillaries extending longitudinally from the first fiber end to the second fiber end, each of the plurality of first nested capillaries (a) disposed within the primary interior of a different one of the plurality of primary capillaries and (b) comprising (i) a first capillary axis that is parallel to the fiber longitudinal axis and (ii) a first nested interior;
a plurality of second nested capillaries extending longitudinally from the first fiber end to the second fiber end, each of the plurality of second nested capillaries (a) disposed within the primary interior of a different one of the plurality of primary capillaries along with a different one of the plurality of first nested capillaries and (b) comprising (i) a second capillary axis that is parallel to the fiber longitudinal axis and (ii) a second nested interior;
a plurality of third nested capillaries extending longitudinally from the first fiber end to the second fiber end, each of the plurality of third nested capillaries (a) disposed within the first nested interior of a different one of the plurality of first nested capillaries and (b) comprising (i) a third capillary axis that is parallel to the fiber longitudinal axis and (ii) a third nested interior; and
an effective core region tangential to the plurality of primary capillaries at a core radius from the fiber longitudinal axis, the plurality of primary capillaries disposed radially outward of the effective core region.

According to a second aspect of the present disclosure, the anti-resonant hollow core optical fiber of the first aspect is presented, wherein each of the plurality of recesses merges with an adjacent recess in both azimuthal directions around the fiber longitudinal axis so that the cladding inner surface forms peaks pointing inward toward the fiber longitudinal axis.

According to a third aspect of the present disclosure, the anti-resonant hollow core optical fiber of the first aspect is presented, wherein the cladding inner surface further defines plateau portions where the cladding inner radius is constant azimuthally around the fiber longitudinal axis, and each of the plurality of recesses are separated from an adjacent recess in both azimuthal directions around the fiber longitudinal axis by a different one of the plateau portions.

According to a fourth aspect of the present disclosure, the anti-resonant hollow core optical fiber of any one of the first through third aspects is presented, wherein the primary outer radius of each of the plurality of primary capillaries is within a range of from 20 μm to 90 μm.

According to a fifth aspect of the present disclosure, the anti-resonant hollow core optical fiber of any one of the first through fourth aspects is presented, wherein each of the plurality of primary capillaries further comprises a primary thickness that is within a range of from 250 nm to 1500 nm.

According to a sixth aspect of the present disclosure, the anti-resonant hollow core optical fiber of any one of the first through fifth aspects is presented, wherein each of the plurality of primary capillaries further comprises a primary thickness that is within ±30% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the primary capillaries.

According to a seventh aspect of the present disclosure, the anti-resonant hollow core optical fiber of any one of the first through sixth aspects is presented, wherein (i) the cladding tube has from 3 to 9 recesses, (ii) the anti-resonant hollow core optical fiber has from 3 to 9 primary capillaries, and (iii) the quantity of recesses and the quantity of primary capillaries are the same.

According to an eighth aspect of the present disclosure, the anti-resonant hollow core optical fiber of any one of the first through seventh aspects is presented, wherein the core radius is within a range of from 5 μm to 100 μm.

According to a ninth aspect of the present disclosure, the anti-resonant hollow core optical fiber of any one of the first through eighth aspects further comprises: a capillary region radius that is tangential to the primary outer surface of each of the plurality of primary capillaries but radially outward of the core radius; and a primary capillary region between the capillary region radius and the core radius, each of the plurality of primary capillaries disposed entirely within the primary capillary region.

According to a tenth aspect of the present disclosure, the anti-resonant hollow core optical fiber of the ninth aspect is presented, wherein the cladding tube occupies an entirety of a volume, outside of the plurality of primary capillaries, that is radially inward of the capillary region radius and radially outward of where adjacent primary capillaries contact or merge.

According to an eleventh aspect of the present disclosure, the anti-resonant hollow core optical fiber of the ninth aspect is presented, wherein (i) bury radial lines extend from the longitudinal axis radially outward through the cladding tube, each of the bury radial lines extending through where different pairs of adjacent primary capillaries contact or merge, and (ii) the cladding tube occupies a portion of a volume, outside of the plurality of primary capillaries that is radially inward of the capillary region radius to a depth from the capillary region radius along each of the bury radial longs toward where the adjacent primary capillaries contact or merge.

According to a twelfth aspect of the present disclosure, the anti-resonant hollow core optical fiber of the eleventh aspect is presented, wherein the depth is from 10% to 85% of a radial distance from the capillary region radius to where the adjacent primary capillaries contact or merge.

According to a thirteenth aspect of the present disclosure, the anti-resonant hollow core optical fiber of any one of the first through twelfth aspects is presented, wherein each of the plurality of first nested capillaries further comprises a first nested outer radius from the first capillary axis that is within a range of from 5 μm to 30 μm.

According to a fourteenth aspect of the present disclosure, the anti-resonant hollow core optical fiber of any one of the first through thirteenth aspects is presented, wherein each of the plurality of first nested capillaries further comprises a first nested thickness that is within a range of from 250 nm to 1500 nm.

According to a fifteenth aspect of the present disclosure, the anti-resonant hollow core optical fiber of any one of the first through fourteenth aspects is presented, wherein each of the plurality of first nested capillaries further comprises a first nested thickness that is within +30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the first nested capillaries.

According to a seventeenth aspect of the present disclosure, the anti-resonant hollow core optical fiber of any one of the first through sixteenth aspects is presented, wherein each of the plurality of second nested capillaries further comprises a second nested thickness that is within a range of from 250 nm to 1500 nm.

According to an eighteenth aspect of the present disclosure, the anti-resonant hollow core optical fiber of any one of the first through seventeenth aspects is presented, wherein each of the plurality of second nested capillaries further comprises a second nested thickness that is within ±30% of a calculated thickness defined by the equation

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries.

According to a nineteenth aspect of the present disclosure, the anti-resonant hollow core optical fiber of any one of the first through eighteenth aspects is presented, wherein each of the plurality of third nested capillaries further comprises a third nested outer radius from the third capillary axis that is within a range of from 3 μm to 15 μm.

According to a twentieth aspect of the present disclosure, the anti-resonant hollow core optical fiber of any one of the first through nineteenth aspects is presented, wherein each of the plurality of third nested capillaries further comprises a third nested thickness that is within a range of from 250 nm to 1500 nm.

According to a twenty-first aspect of the present disclosure, the anti-resonant hollow core optical fiber of any one of the first through twentieth aspects is presented, wherein each of the plurality of third nested capillaries further comprises a third nested thickness that is within +30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the third nested capillaries.

According to a twenty-second aspect of the present disclosure, the anti-resonant hollow core optical fiber of any one of the first through twenty-first aspects further comprises a plurality of fourth nested capillaries extending longitudinally from the first fiber end to the second fiber end, each of the plurality of fourth nested capillaries (a) disposed within the second nested interior of a different one of the plurality of second nested capillaries and (b) comprising (i) a fourth capillary axis that is parallel to the fiber longitudinal axis and (ii) a fourth nested interior.

According to a twenty-third aspect of the present disclosure, the anti-resonant hollow core optical fiber of the twenty-second aspect is presented, wherein each of the plurality of fourth nested capillaries further comprises a fourth nested outer radius from the fourth capillary axis that is within a range of from 3 μm to 15 μm.

According to a twenty-fourth aspect of the present disclosure, the anti-resonant hollow core optical fiber of any one of the twenty-second through twenty-third aspects is presented, wherein each of the plurality of fourth nested capillaries further comprises a fourth nested thickness that is within a range of from 250 nm to 1500 nm.

According to a twenty-fifth aspect of the present disclosure, the anti-resonant hollow core optical fiber of any one of the twenty-second through twenty-fourth aspects is presented, wherein each of the plurality of fourth nested capillaries further comprises a fourth nested thickness that is within ±30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the fourth nested capillaries.

According to a twenty-sixth aspect of the present disclosure, the anti-resonant hollow core optical fiber of any one of the first through twenty-fifth aspects is presented, wherein the primary capillary contacts an adjacent one of the plurality of primary capillaries at a contact point and the first nested capillary contacts the primary inner surface at a point radially outward of the contact point.

According to a twenty-seventh aspect of the present disclosure, the anti-resonant hollow core optical fiber of the twenty-sixth aspects is presented, wherein the second nested capillary contacts the primary inner surface at a point radially outward of the contact point.

According to a twenty-eighth aspect of the present disclosure, the anti-resonant hollow core optical fiber of any one of the twenty-sixth through twenty-seventh aspects is presented, wherein a point of contact of the third nested capillary with the first nested capillary aligns with a point of contact of the first nested capillary with the primary inner surface in a radial direction from the fiber longitudinal axis.

According to a twenty-ninth aspect of the present disclosure, the anti-resonant hollow core optical fiber of the twenty-eighth aspect is presented, wherein a point of contact of the fourth nested capillary with the second nested capillary aligns with a point of contact of the second nested capillary with the primary inner surface in a radial direction from the fiber longitudinal axis.

According to a thirtieth aspect of the present disclosure, the anti-resonant hollow core optical fiber of any one of the first through twenty-ninth aspects is presented, wherein a series of primary radial lines extends from the fiber longitudinal axis through (i) the primary longitudinal axis of each of the plurality of primary capillaries and (ii) the cladding inner surface, and each of the plurality of first nested capillaries is paired with a different one of the plurality of second nested capillaries within a different one of the plurality of primary capillaries, the first nested capillary disposed to one side of the primary radial line and the second nested capillary disposed to another side of the primary radial line.

According to a thirty-first aspect of the present disclosure, the anti-resonant hollow core optical fiber of the thirtieth aspect is presented, wherein a first nested radial line extending from the primary longitudinal axis through the first capillary axis forms a first angle within a range of from 70 degrees to 110 degrees relative to the primary radial line.

According to a thirty-second aspect of the present disclosure, the anti-resonant hollow core optical fiber of the thirty-first aspect is presented, wherein a second nested radial line extending from the primary longitudinal axis through the second capillary axis forms a second angle within a range of from 70 degrees to 110 degrees relative to the primary radial line.

According to a thirty-third aspect of the present disclosure, the anti-resonant hollow core optical fiber of any one of the first through thirty-second aspects is presented, wherein the anti-resonant hollow core optical fiber exhibits a confinement loss for the fundamental mode of electromagnetic radiation at each wavelength in a wavelength range from 1400 nm to 1600 nm that is less than or equal to 0.20 dB/km.

According to a thirty-fourth aspect of the present disclosure, the anti-resonant hollow core optical fiber of any one of the first through thirty-second aspects is presented, wherein the anti-resonant hollow core optical fiber exhibits a confinement loss for the fundamental mode of electromagnetic radiation at each wavelength in a wavelength range from 1400 nm to 1600 nm that is less than or equal to 0.10 dB/km.

According to a thirty-fifth aspect of the present disclosure, the anti-resonant hollow core optical fiber of any one of the first through thirty-second aspects is presented, wherein the anti-resonant hollow core optical fiber exhibits a confinement loss for the fundamental mode of electromagnetic radiation at each wavelength in a wavelength range from 1400 nm to 1600 nm that is less than or equal to 0.05 dB/km.

According to a thirty-sixth aspect of the present disclosure, the anti-resonant hollow core optical fiber of any one of the first through thirty-second aspects is presented, wherein the anti-resonant hollow core optical fiber exhibits a confinement loss for the fundamental mode of electromagnetic radiation at each wavelength in a wavelength range from 1400 nm to 1600 nm that is less than or equal to 0.03 dB/km.

According to a thirty-seventh aspect of the present disclosure, the anti-resonant hollow core optical fiber of any one of the first through thirty-sixth aspects is presented, wherein the anti-resonant hollow core optical fiber exhibits a confinement loss for higher order modes of electromagnetic radiation at each wavelength in a wavelength range from 1400 nm to 1600 nm that is greater than or equal to 0.50 dB/km.

According to a thirty-eighth aspect of the present disclosure, the anti-resonant hollow core optical fiber of any one of the first through thirty-sixth aspects is presented, wherein the anti-resonant hollow core optical fiber exhibits a confinement loss for higher order modes of electromagnetic radiation at each wavelength in a wavelength range from 1400 nm to 1600 nm that is greater than or equal to 10 dB/km.

According to a thirty-ninth aspect of the present disclosure, the anti-resonant hollow core optical fiber of any one of the first through thirty-sixth aspects is presented, wherein anti-resonant hollow core optical fiber exhibits a confinement loss for higher order modes of electromagnetic radiation at each wavelength in a wavelength range from 1400 nm to 1600 nm that is greater than or equal to 100 dB/km.

According to a fortieth aspect of the present disclosure, a method of manufacturing an anti-resonant hollow core optical fiber comprises: (a) a preform recess formation step comprising forming a plurality of preform recesses into a cladding preform inner surface of a cladding preform tube through which a cladding preform longitudinal axis extends, each of the plurality of preform recesses disposed longitudinally from a first preform end to a second preform end of the cladding preform tube; (b) a primary preform capillary arrangement step comprising arranging a plurality of primary preform capillaries within the plurality of preform recesses of the cladding preform tube, each of the plurality of primary preform capillaries (i) comprising an outer primary preform surface at an outer primary preform radius from a primary capillary preform axis parallel to the cladding preform longitudinal axis, (ii) contacting an adjacent primary preform capillary in both azimuthal directions around the cladding preform longitudinal axis, and (iii) contacting the cladding preform inner surface, wherein, the plurality of preform recesses is dimensioned to substantially match the outer primary preform radius of the plurality of primary preform capillaries; (c) a first nested preform capillary arrangement step comprising arranging a plurality of first nested preform capillaries in the plurality of primary preform capillaries, each of the plurality of primary preform capillaries including one of the plurality of first nested preform capillaries; and (d) a second nested preform capillary arrangement step comprising arranging a plurality of second nested preform capillaries in the plurality of primary preform capillaries, each of the plurality of primary preform capillaries including one of the plurality of first nested preform capillaries and one of the plurality of second nested preform capillaries.

According to a forty-first aspect of the present disclosure, the method of the fortieth aspect is presented, wherein each of the plurality of preform recesses merge with an adjacent preform recess in both azimuthal directions around the preform longitudinal axis so that the cladding preform inner surface forms peaks pointing inward toward the cladding preform longitudinal axis.

According to a forty-second aspect of the present disclosure, the method of the fortieth aspect is presented, wherein the cladding preform inner surface forms plateaus of constant radius from the cladding preform longitudinal axis between adjacent preform recesses in both azimuthal directions around the preform longitudinal axis.

According to a forty-third aspect of the present disclosure, the method of any of the fortieth through forty-second aspects comprises a third nested preform capillary arrangement step comprising arranging a plurality of third nested preform capillaries in the plurality of first nested preform capillaries, each of the plurality of first nested preform capillaries including one of the plurality of third nested preform capillaries.

According to a forty-fourth aspect of the present disclosure, the method of the forty-third aspect further comprises a fourth nested preform capillary arrangement step comprising arranging a plurality of fourth nested preform capillaries in the plurality of second nested preform capillaries, each of the plurality of second nested preform capillaries including one of the plurality of fourth nested preform capillaries.

According to a forty-fifth aspect of the present disclosure, the method of any of the fortieth through forty-fourth aspects comprises a drawing step comprising drawing an anti-resonant hollow core optical fiber from the preform.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of an anti-resonant hollow core optical fiber of the present disclosure, illustrating a cladding tube and anti-resonant cladding elements with primary capillaries that contact and contain nested capillaries disposed within the cladding tube;

FIG. 2A is a cross-sectional view of the anti-resonant hollow core optical fiber taken through line II-II of FIG. 1, illustrating the cladding tube (but not the anti-resonant cladding elements) having a plurality of recesses into a cladding inner surface and forming peaks pointing toward a fiber longitudinal axis;

FIG. 2B is a cross-sectional view of an alternative embodiment of anti-resonant hollow core optical fiber, illustrating a cladding tube (but not anti-resonant cladding elements) having a plurality of recesses into a cladding inner surface and forming plateaus facing toward a fiber longitudinal axis;

FIG. 2C is a cross-sectional view of the primary capillary and nested capillaries of an embodiment of the anti-resonant cladding elements of an anti-resonant hollow core optical fiber;

FIG. 2D is a cross-sectional view showing angular positioning of nested capillaries of embodiments of the anti-resonant cladding elements of an anti-resonant hollow core optical fiber;

FIG. 2E is a cross-sectional view showing points of contact of selected primary capillaries and nested capillaries of an embodiment of the anti-resonant cladding elements of an anti-resonant hollow core optical fiber;

FIG. 2F are cross-sectional views showing configurations of anti-resonant cladding elements that illustrate various arrangements of the points of contact of the nested capillaries;

FIG. 3A is a cross-sectional view of the anti-resonant hollow core optical fiber taken through line IIIA-IIIA of FIG. 1, illustrating (a) the anti-resonant cladding elements and (b) adjacent recesses forming peaks pointing toward the fiber longitudinal axis;

FIG. 3B is a cross-sectional view of the anti-resonant hollow core optical fiber taken through line IIIB-IIIB of FIG. 1, illustrating the cladding inner surface forming the plurality of recesses and plateaus between adjacent recesses so that the recesses and plateaus alternate azimuthally around the fiber longitudinal axis;

FIG. 4 is a schematic diagram of a method of making the anti-resonant hollow core optical fiber, setting forth a preform recess formation step, a primary preform capillary arrangement step, and a drawing step;

FIG. 5 is a schematic diagram of the preform recess formation step, illustrating a plurality of recesses having been formed into a cladding preform inner surface of a cladding preform tube;

FIG. 6 is a schematic diagram of the primary preform capillary arrangement step, illustrating a plurality of primary preform capillaries having been coupled to the cladding preform inner surface within the plurality of recesses, with adjacent primary preform capillaries contacting each other;

FIG. 7 is a cross-sectional view taken along line VII-VII of FIG. 7, illustrating outer primary preform surfaces of adjacent primary preform capillaries contacting;

FIG. 8 is a schematic diagram of the drawing step, illustrating the anti-resonant hollow core optical fiber being drawn from the optical fiber preform

FIG. 9 is a cross-sectional view of an exemplary anti-resonant hollow core optical fiber.

FIG. 10 is a graph plotting confinement loss for both (i) the fundamental mode and (ii) higher order modes as a function of wavelength of electromagnetic radiation for an embodiment of an anti-resonant hollow core optical fiber.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

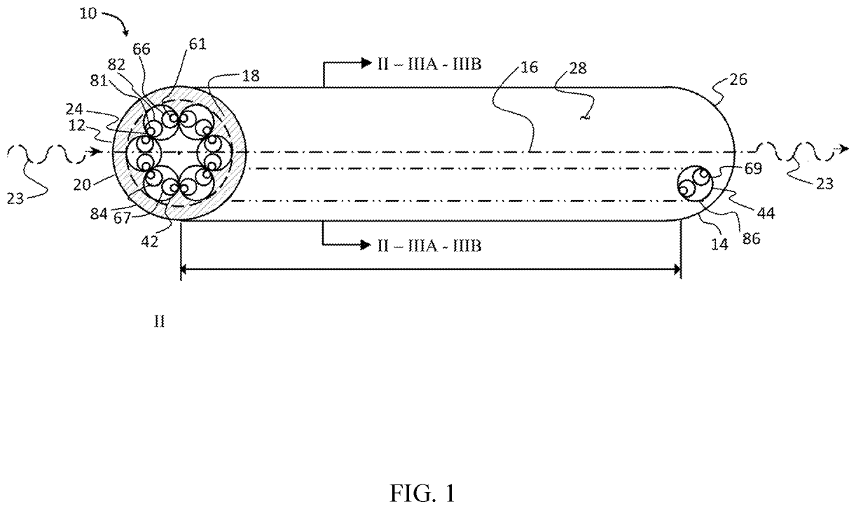

Referring to FIGS. 1-3B, an anti-resonant hollow core optical fiber 10 includes a first fiber end 12, a second fiber end 14, a fiber longitudinal axis 16, a cladding tube 18, a plurality of primary capillaries 20, and an effective core region 22. The fiber longitudinal axis 16 extends from the first fiber end 12 to the second fiber end 14. In use, electromagnetic radiation 23 enters into the first fiber end 12, transmits predominantly within the effective core region 22, and exits the second fiber end 14.

The cladding tube 18 likewise extends, azimuthally around the fiber longitudinal axis 16, from the first fiber end 12 to the second fiber end 14. The cladding tube 18 includes a first cladding end 24 and a second cladding end 26. The first cladding end 24 is proximate, and may at least partially define, the first fiber end 12. The second cladding end 26 is proximate, and may at least partially define, the second fiber end 14.

The cladding tube 18 further includes a cladding outer surface 28 and a cladding inner surface 30. The cladding outer surface 28 is at a cladding outer radius 32 from the fiber longitudinal axis 16. The cladding inner surface 30 is at a cladding inner radius 34 from the fiber longitudinal axis 16. The cladding inner surface 30 defines a cladding interior 36. The cladding inner radius 34 varies as a function of azimuthal position around the fiber longitudinal axis 16. The cladding inner surface 30 thus defines a plurality of recesses 38.

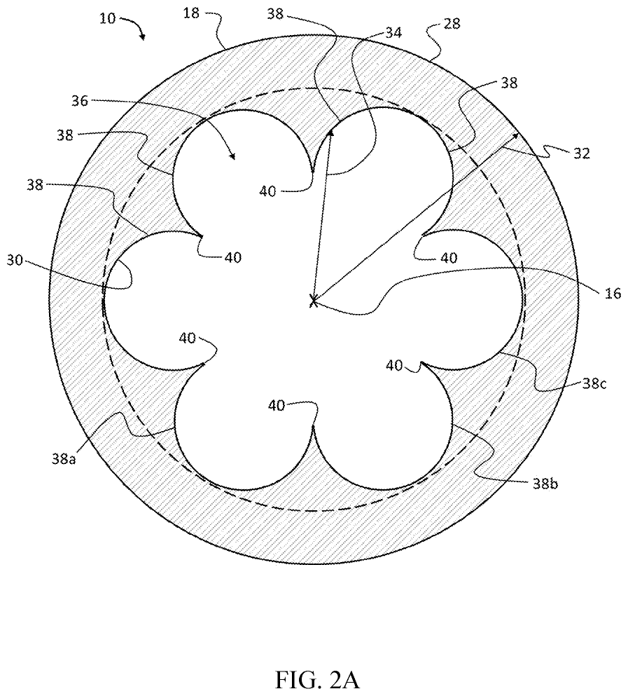

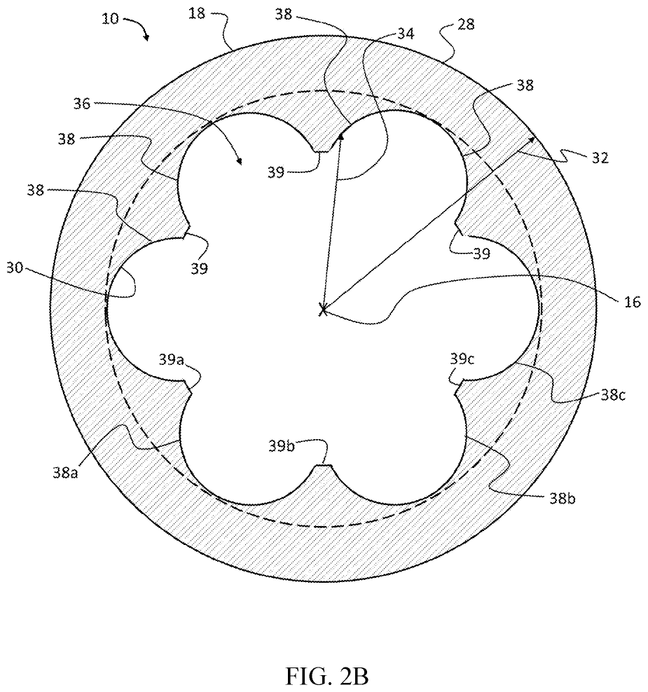

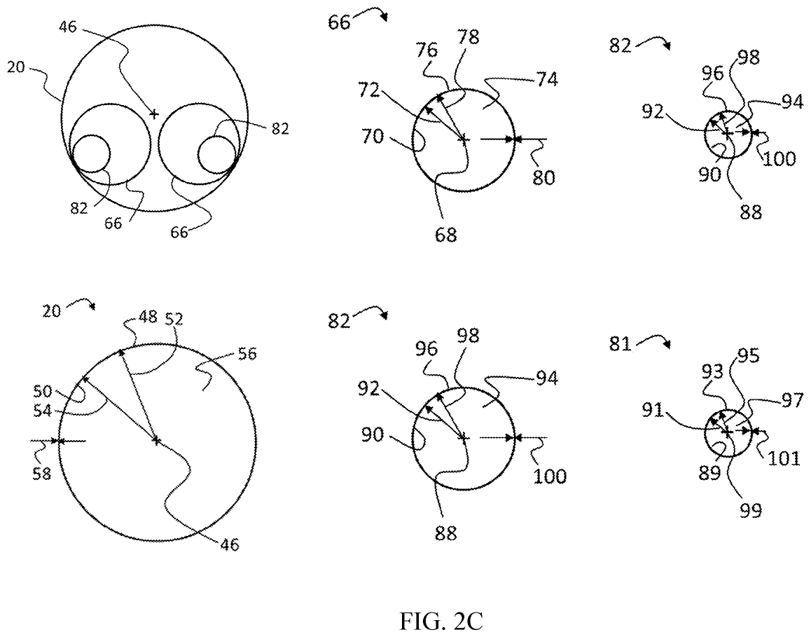

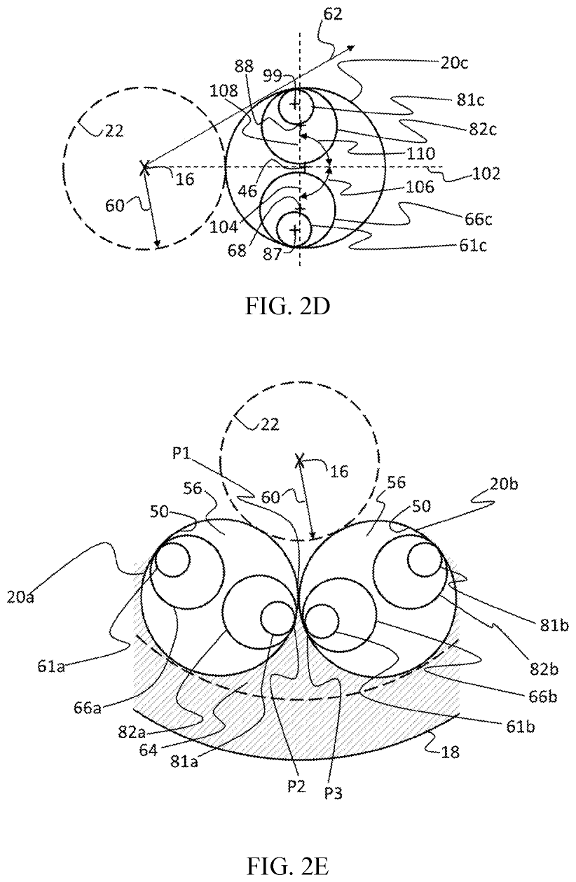

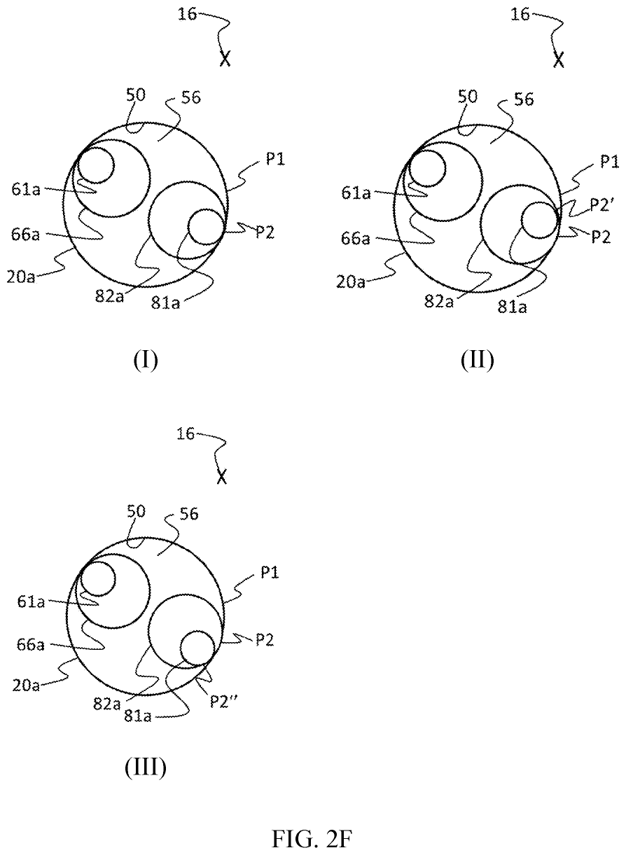

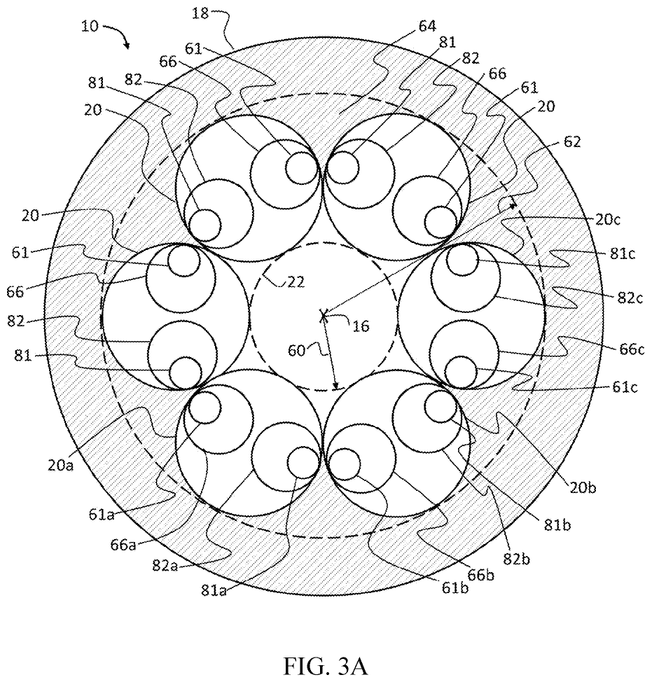

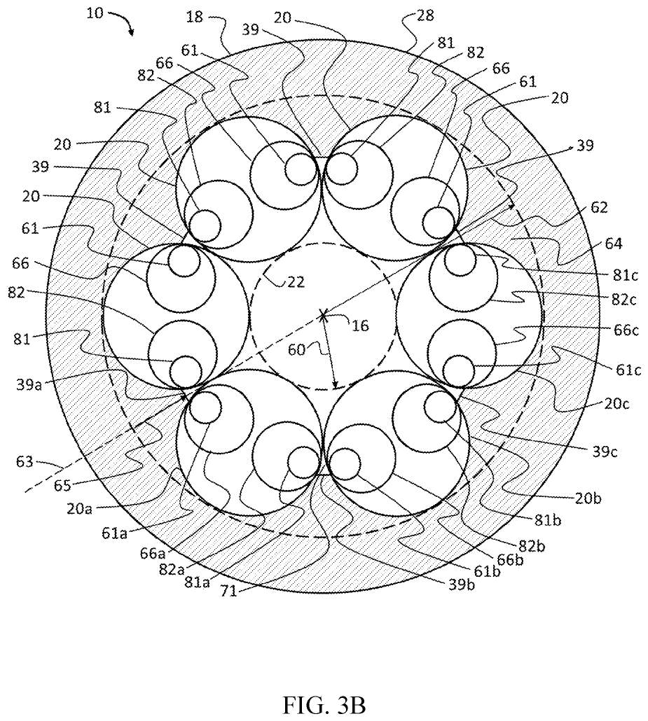

In embodiments (see FIGS. 2A and 3A), each of the plurality of recesses 38 merges with an adjacent recess 38 in both azimuthal directions around the fiber longitudinal axis 16. For example, the recess 38b merges with the recess 38c in one azimuthal direction around the fiber longitudinal axis 16 and additionally with the recess 38a in the other azimuthal direction. The bi-directional merging of the plurality of recesses 38 thus forms peaks 40. The peaks 40 point inward toward the fiber longitudinal axis 16. The peaks 40 are disposed azimuthally around the fiber longitudinal axis 16.

In other embodiments (FIGS. 2B and 3B), the cladding inner surface 30 presents both the plurality of recesses 38 where the cladding inner radius 34 varies azimuthally around the fiber longitudinal axis 16 and plateaus 39 where the cladding inner radius 34 is constant azimuthally around the fiber longitudinal axis 16. The cladding inner surface 30 alternates between the recesses 38 and the plateaus 39 azimuthally around the fiber longitudinal axis 16. Each one of the plateaus 39 are disposed between different pairs of adjacent recesses 38. Each of the plurality of recesses 38 are separated from the adjacent recess 38 in both azimuthal directions around the fiber longitudinal axis 16 by a different one of the plateaus 39.

The plurality of primary capillaries 20 is disposed within the cladding interior 36. The plurality of primary capillaries 20 is arranged azimuthally around the fiber longitudinal axis 16. Each of the plurality of primary capillaries 20 includes a capillary first end 42 and a capillary second end 44. The capillary first end 4λ is proximate, and may at least partially define, the first fiber end 12. The capillary second end 44 is proximate, and may at least partially define, the second fiber end 14.

Each of the plurality of primary capillaries 20 further includes a primary longitudinal axis 46 that is parallel to the fiber longitudinal axis 16 (FIG. 2C). In addition, each of the plurality of primary capillaries 20 further includes a primary outer surface 48 and a primary inner surface 50. The primary outer surface 48 is at a primary outer radius 52 from the primary longitudinal axis 46. The primary inner surface 50 is at a primary inner radius 54 from the primary longitudinal axis 46. The difference between the primary outer radius 52 and the primary inner radius 54 is the thickness 58. The primary inner surface 50 defines a primary interior 56. For a given core radius 60 of effective core region 22, the primary outer radius 52 varies with the number of primary capillaries 20 (see below). In embodiments, the primary outer radius 52 is greater than or equal to 15 μm, or greater than or equal to 20 μm, or greater than or equal to 25 μm, or greater than or equal to 30 μm, or greater than or equal to 40 μm, or greater than or equal to 50 μm, or greater than or equal to 60 μm, or greater than or equal to 70 μm, or less than or equal to 90 μm, or less than or equal to 80 μm, or less than or equal to 70 μm, or less than or equal to 60 μm, or less than or equal to 50 μm, or less than or equal to 40 μm, or in the range from 20 μm to 90 μm, or in the range from 20 μm to 80 μm, or in the range from 25 μm to 80 μm, or in the range from 25 μm to 75 μm, or in the range from 30 μm to 70 μm. The primary outer radius 52 of the different ones of the primary capillaries 20 may be the same or different.

Each of the plurality of primary capillaries 20 further includes a primary thickness 58. The primary thickness 58 is the distance measured radially from the primary longitudinal axis 46 between the primary inner surface 50 and the primary outer surface 48. In embodiments, the primary thickness 58 is within a range of from 250 nm to 1500 nm. For example, the primary thickness 58 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 400 nm to 600 nm, from 500 nm to 850 nm, from 700 nm to 1400 nm, from 800 nm to 1300 nm, and so on). In embodiments, the primary thickness 58 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the primary capillaries. The primary thickness 58 of the different ones of the primary capillaries 20 may be the same or different.

Each of the plurality of primary capillaries 20 is disposed within a different one of the plurality of recesses 38. For example, the primary capillary 20a is disposed within the recess 38a, the primary capillary 20b is disposed within the recess 38b, and the primary capillary 20c is disposed within the recess 38c. Each of the primary capillaries 20 contacts the cladding inner surface 30 and can be fused thereto. Each of the primary capillaries 20 contacts or merges with an adjacent one of the primary capillaries 20 in both azimuthal directions around the fiber longitudinal axis 16. For example, the primary capillary 20b contacts or merges with the primary capillary 20c in one azimuthal direction, and the primary capillary 20b contacts or merges with the primary capillary 20a in the other azimuthal direction.

In embodiments of the anti-resonant hollow optical fiber 10 that include the plateaus 39 of the cladding inner surface 30 (see FIG. 3B), the plurality of primary capillaries 20 and the plateaus 39 alternate azimuthally around the fiber longitudinal axis 16. For example, plateau 39b is disposed between capillary 20a and capillary 20b, and plateau 39c is disposed between capillary 20b and capillary 20c.

The anti-resonant hollow core optical fiber 10 can have any number of primary capillaries 20. In embodiments, the cladding tube 18 has a quantity of recesses 38 that is equal to the number of primary capillaries 20 of the anti-resonant hollow core optical fiber 10. In embodiments, the cladding tube 18 has from 3 to 9 recesses 38. For example, the cladding tube 18 can have 3, 4, 5, 6, 7, 8, or 9 recesses 38. The cladding tube 18 could have less than 3 or greater than 9 recesses 38. The anti-resonant hollow core optical fiber 10 can include from 3 to 9, or from 3 to 6, or from 3 to 5, or from 4 to 8 primary capillaries 20. For example, the anti-resonant hollow core fiber can have 3, 4, 5, 6, 7, 8, or 9 primary capillaries 20. The anti-resonant hollow core optical fiber 10 could also have less than 3 or greater than 9 primary capillaries 20.

The effective core region 22 is within the cladding interior 36. The effective core region 22 is tangential to the primary outer surface 48 of each of the plurality of primary capillaries 20. The effective core region 22 is at a core radius 60 from the fiber longitudinal axis 16. The effective core region 22 extends between the first fiber end 12 and the second fiber end 14. The plurality of primary capillaries 20 is disposed radially outward of the effective core region 22. In embodiments, the core radius 60 is greater than or equal to 5 μm, or greater than or equal to 10 μm, or greater than or equal to 15 μm, or greater than or equal to 20 μm, or greater than or equal to 25 μm, or greater than or equal to 30 μm, or greater than or equal to 35 μm, or greater than or equal to 40 μm, or less than or equal to 70 μm, or less than or equal to 65 μm, or less than or equal to 60 μm, or less than or equal to 55 μm, or less than or equal to 50 μm, or less than or equal to 45 μm, or less than or equal to 40 μm, or in the range from 5 μm to 100 μm, or in the range from 5 μm to 85 μm, or in the range from 5 μm to 70 μm, or in the range from 10 μm to 60 μm, or in the range from 10 μm to 50 μm, or in the range from 10 μm to 40 μm, or in the range from 10 μm to 30 μm.

In embodiments, the anti-resonant hollow core optical fiber 10 further includes a capillary region radius 62 and a primary capillary region 64. The capillary region radius 6λ is tangential to the primary outer surface 48 of each of the plurality of primary capillaries 20 but radially outward of the core radius 60. The primary capillary region 64 is disposed between the capillary region radius 62 and the core radius 60. Each of the plurality of primary capillaries 20 is disposed entirely within the primary capillary region 64.

In embodiments (see FIG. 3A), the cladding tube 18 occupies an entirety of the primary capillary region 64, outside of the primary capillaries 20, that is radially inward of the capillary region radius 62 and radially outward of where adjacent primary capillaries 20 contact or merge. Stated another way, in those embodiments, the anti-resonant hollow core optical fiber 10 is substantially free of air gaps within the primary capillary region 64 created by the cladding inner surface 30 and the primary outer surfaces 48 of adjacent primary capillaries 20 radially inward of the cladding inner surface 30. “Substantially free” here means that the anti-resonant hollow core optical fiber 10 is designed to be free of such air gaps but manufacturing imprecision may result in the generation of such air gaps.

In other embodiments (see FIG. 3B), where the plurality of recesses 38 stop short of merging and instead the inner cladding surface 30 forms the plateaus 39, the cladding tube 18 does not occupy an entirety of the primary capillary region 64, outside of the primary capillaries 30, that is radially inward of the capillary region radius 62 and radially outward of where adjacent primary capillaries 20 contact or merge. As a conceptual tool, for these embodiments, bury radial lines 63 extends from the fiber longitudinal axis 16 and radially outward through the cladding tube. Each of the bury radial lines 63 extend through a different one of the plateaus 39 and where a different pairs of the primary capillaries 20 contact or merge. The plateaus 39 reside at a depth 65 from the capillary region radius 62 along each of the bury radial lines 63 toward the fiber longitudinal axis 16. The cladding tube 18 occupies a portion of the volume (e.g., a portion of the primary capillary region 64), outside of the plurality of primary capillaries 20, that is radially inward of the capillary region radius 62 to the depth 65 from the capillary region radius 62 along each of the bury radial lines 63 toward where the adjacent primary capillaries 20 contact or merge. Air pockets 71 occupy the volume between the plateau 39 of the inner cladding surface 30 and where adjacent primary capillaries 20 contact or merge. The air pockets 71 are arranged azimuthally around the fiber longitudinal axis 16. The depth 65 can be from greater than 0% of a radial distance from the capillary region radius 62 to where the adjacent primary capillaries 20 contact or merge to less than 100% of that radial distance. For example, the depth 65 can be 10%, 15%, 20%, 25%, 30%, 35%, 40%, 45%, 50%, 55%, 60%, 65%, 70%, 75%, 85%, or within any range bound by any two of those values of that radial distance (e.g., from 20% to 60%, from 15% to 40%, from 10% to 85%, and so on). In the embodiment of FIG. 3A without plateaus, the depth 65 corresponds to 100% of the radial distance from the capillary region radius 62 to where the adjacent primary capillaries 20 contact or merge. Further, the depth 65 can be greater than 0 μm, or greater than or equal to 1 μm, or greater than or equal to 3 μm, or greater than or equal to 5 μm, or greater than or equal to 10 μm, or greater than or equal to 15 μm, or greater than or equal to 20 μm, or greater than or equal to 25 μm, or greater than or equal to 30 μm, or greater than or equal to 35 μm, or greater than or equal to 40 μm, or greater than or equal to 45 μm, or greater than or equal to 50 μm, or greater than or equal to 55 μm, or greater than or equal to 60 μm, or greater than or equal to 65 μm, or in the range from 1 μm to 80 μm, or in the range from 3 μm to 75 μm, or in the range from 5 μm to 70 μm, or in the range from 10 μm to 65 μm, or in the range from 15 μm to 60 μm, or in the range from 20 μm to 55 μm, or in the range from 25 μm to 50 μm, or in the range from 30 μm to 45 μm. The depth 65 of the different ones of the plateaus 39 may be the same or different. In embodiments without plateaus (FIG. 3A), the depth 65 corresponds to 100% of the radial distance from the capillary region radius 62 to where the adjacent primary capillaries 20 contact or merge.

In embodiments, the anti-resonant hollow core optical fiber 10 further includes a plurality of first nested capillaries 66. The plurality of first nested capillaries 66 extends longitudinally within the cladding tube 18 from the first fiber end 12 to the second fiber end 14. Each of the plurality of first nested capillaries 66 includes an end 67 (see FIG. 1) disposed proximate the first cladding end 24 and can at least partially define the first fiber end 12. Each of the first nested capillaries 66 includes another end 69 disposed proximate the second cladding end 26 and can at least partially define the second fiber end 14.

Each of the first nested capillaries 66 is disposed within the primary interior 56 of a different one of the plurality of primary capillaries 20. Each of the first nested capillaries 66 includes a first capillary axis 68 (FIG. 2C). The first capillary axis 68 is parallel to both the fiber longitudinal axis 16 and the primary longitudinal axis 46. Each of the first nested capillaries 66 includes a first nested inner surface 70 at a first nested inner radius 72 from the first capillary axis 68. The first nested inner surface 70 defines a first nested interior 74.

Each of the first nested capillaries 66 further includes a first nested outer surface 76 at a first nested outer radius 78 from the first capillary axis 68. In embodiments, the first nested outer radius 78 is greater than or equal to 5 μm, or greater than or equal to 7 μm, or greater than or equal to 10 μm, or greater than or equal to 12 μm, or greater than or equal to 15 μm, or greater than or equal to 17 μm, or greater than or equal to 20 μm, or greater than or equal to 22 μm, or greater than or equal to 25 μm, or in the range from 5 μm to 30 μm, or in the range from 7 μm to 25 μm, or in the range from 10 μm to 22 μm, or in the range from 12 μm to 20 μm. The first nested outer radius 78 of the different ones of the first nested capillaries may be the same or different.

Each of the first nested capillaries 66 further includes a first nested thickness 80. The first nested thickness 80 is the distance measured radially from the first capillary axis 68 between the first nested inner surface 70 and the first nested outer surface 76. In embodiments, the first nested thickness 80 is within a range of from 250 nm to 1500 nm. For example, the first nested thickness 80 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the first nested thickness 80 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the first nested capillaries 66. The first nested thickness 80 of the different ones of the first nested capillaries 66 may be the same or different.

In embodiments, the anti-resonant hollow core optical fiber 10 further includes a plurality of second nested capillaries 82. The plurality of second nested capillaries 82 extends longitudinally from the first fiber end 12 to the second fiber end 14. Each of the plurality of second nested capillaries 82 includes an end 84 (see FIG. 1) disposed proximate the first cladding end 24 and can at least partially define the first fiber end 12. Each of the second nested capillaries 82 includes another end 86 disposed proximate the second cladding end 26 and can at least partially define the second fiber end 14.

Each of the plurality of second nested capillaries 82 is disposed within the primary interior 56 of a different one of the plurality of primary capillaries 20. Each of the second nested capillaries 82 shares the primary interior 56 of one of the primary capillaries 20 with a different one of the plurality of first nested capillaries 66. For example, the second nested capillary 82a and the first nested capillary 66a are disposed within the primary capillary 20a, the second nested capillary 82b and the first nested capillary 66b are disposed within the primary capillary 20b, the second nested capillary 82c and the first nested capillary 66c are disposed within the primary capillary 20c, and so on. Each of the second nested capillaries 82 includes a second capillary axis 88. The second capillary axis 88 is parallel to the fiber longitudinal axis 16, the primary longitudinal axis 46, and the first capillary axis 68. Each of the second nested capillaries 82 includes a second nested inner surface 90 at a second nested inner radius 92 from the second capillary axis 88. The second nested inner surface 90 defines a second nested interior 94.

Each of the second nested capillaries 82 further includes a second nested outer surface 96 at a second nested outer radius 98 from the second capillary axis 88. In embodiments, the second nested outer radius 98 is greater than or equal to 5 μm, or greater than or equal to 7 μm, or greater than or equal to 10 μm, or greater than or equal to 12 μm, or greater than or equal to 15 μm, or greater than or equal to 17 μm, or greater than or equal to 20 μm, or greater than or equal to 22 μm, or greater than or equal to 25 μm, or in the range from 5 μm to 30 μm, or in the range from 7 μm to 25 μm, or in the range from 10 μm to 22 μm, or in the range from 12 μm to 20 μm. The second nested outer radius 98 of the different ones of the second nested capillaries 82 may be the same or different. The second nested outer radius 98 of the different ones of the second nested capillaries 82 may be the same as or different from the first nested outer radius 78 of the first nested capillaries 66.

Each of the second nested capillaries 82 further includes a second nested thickness 100. The second nested thickness 100 is the distance measured radially from the second capillary axis 88 between the second nested inner surface 90 and the second nested outer surface 96. In embodiments, the second nested thickness 100 is within a range of from 250 nm to 1500 nm. For example, the second nested thickness 100 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 1150 nm to 1400 nm, and so on). In embodiments, the second nested thickness 100 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries 82. The second nested thickness 100 of the different ones of the second nested capillaries 82 are the same or different. The second nested thickness 100 of the different ones of the second nested capillaries 82 are the same as or different from the first nested thickness 80 of the first nested capillaries 66.

In embodiments, a plurality of primary radial lines 102 extends from the fiber longitudinal axis 16 through (i) the primary longitudinal axis 46 of each of the plurality of primary capillaries 20 and (ii) through the cladding inner surface 30 (see representative depiction of primary capillary 20C in FIG. 2D). As mentioned, each of the plurality of first nested capillaries 66 can be paired with a different one of the plurality of second nested capillaries 82 within a different one of the plurality of primary capillaries 20. In such instances, within each of the plurality of primary capillaries 20, the first nested capillary 66 is disposed to one side of the primary radial line 102 and the second nested capillary 8λ is disposed to another side of the primary radial line 102. It should be understood that the plurality of primary radial lines 10λ is not a physical component of the anti-resonant hollow core optical fiber 10 but rather is a conceptual tool to help explain possible spatial orientation of the plurality of first nested capillaries 66 and the plurality of second nested capillaries 82 within the plurality of primary capillaries 20.

In embodiments, as another conceptual tool, within each of the plurality of primary capillaries 20, a first nested radial line 104 extends from the primary longitudinal axis 46 and through the first capillary axis 68. The first nested radial line 104 forms a first angle 106 relative to the primary radial line 102. In some instances, the first angle 106 is within a range of from 70 degrees to 110 degrees. For example, the first angle 106 can be 70 degrees, 75 degrees, 80 degrees, 85 degrees, 90 degrees, 95 degrees, 100 degrees, 105 degrees, 110 degrees, or within any range bound by any two of those values (e.g., from 80 degrees to 95 degrees, from 85 degrees to 100 degrees, and so on). The first angle 106 of the different ones of the first nested capillaries 66 are the same or different.

In embodiments, as another conceptual tool, within each of the plurality of primary capillaries 20, a second nested radial line 108 extends from the primary longitudinal axis 46 and through the second capillary axis 88. The second nested radial line 108 forms a second angle 110 relative to the primary radial line 102. In some instances, the second angle 110 is within a range of from 70 degrees to 110 degrees. For example, the second angle 110 can be 70 degrees, 75 degrees, 80 degrees, 85 degrees, 90 degrees, 95 degrees, 100 degrees, 105 degrees, 110 degrees, or within any range bound by any two of those values (e.g., from 80 degrees to 95 degrees, from 85 degrees to 100 degrees, and so on). The first angle 106 and the second angle 110 concern relative positioning of the first nested capillary 66 and the second nested capillary 82 within any particular of the primary capillaries 20. The second angle 110 of the different ones of the second nested capillaries 66 are the same or different. The second angle 110 of the second nested capillaries 66 are the same as or different from the first angle 106 of the first nested capillaries 66 in magnitude.

In embodiments, the anti-resonant hollow core optical fiber 10 further includes a plurality of third nested capillaries 61. The plurality of third nested capillaries 61 extends longitudinally from the first fiber end 12 to the second fiber end 14. Each of the plurality of third nested capillaries 61 includes an end (not shown) disposed proximate the first cladding end 24 and can at least partially define the first fiber end 12. Each of the third nested capillaries 61 includes another end (not shown) disposed proximate the second cladding end 26 and can at least partially define the second fiber end 14.

Each of the plurality of third nested capillaries 61 is disposed within the first nested interior 74 of a different one of the first nested capillaries 66. Each of the third nested capillaries 61 includes a third capillary axis 87. The third capillary axis 87 is parallel to the fiber longitudinal axis 16, the primary longitudinal axis 46, and the first capillary axis 68. Each of the third nested capillaries 61 includes a third nested inner surface 73 at a third nested inner radius 75 from the third capillary axis 87. The third nested inner surface 73 defines a third nested interior 83.

Each of the third nested capillaries 61 further includes a third nested outer surface 77 at a third nested outer radius 79 from the third capillary axis 87. In embodiments, the third nested outer radius 79 is greater than or equal to 3 μm, or greater than or equal to 4 μm, or greater than or equal to 5 μm, or greater than or equal to 6 μm, or greater than or equal to 7 μm, or greater than or equal to 8 μm, or greater than or equal to 9 μm, or greater than or equal to 10 μm, or greater than or equal to 11 μm, or in the range from 3 μm to 15 μm, or in the range from 4 μm to 13 μm, or in the range from 5 μm to 11 μm, or in the range from 6 μm to 10 μm. The third nested outer radius 79 of the different ones of the third nested capillaries 61 may be the same or different. The third nested outer radius 79 of the different ones of the third nested capillaries 61 may be the same as or different from the fourth nested outer radius 95 of the fourth nested capillaries 81.

Each of the third nested capillaries 61 further includes a third nested thickness 85. The third nested thickness 85 is the distance measured radially from the third capillary axis 87 between the third nested inner surface 73 and the third nested outer surface 77. In embodiments, the third nested thickness 85 is within a range of from 250 nm to 1500 nm. For example, the third nested thickness 85 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 1150 nm to 1400 nm, and so on). In embodiments, the third nested thickness 85 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the third nested capillaries 61. The third nested thickness 85 of the different ones of the third nested capillaries 61 are the same or different. The third nested thickness 85 of the different ones of the third nested capillaries 61 are the same as or different from the fourth nested thickness 101 of the fourth nested capillaries 81.

In embodiments, the anti-resonant hollow core optical fiber 10 further includes a plurality of fourth nested capillaries 81. The plurality of fourth nested capillaries 81 extends longitudinally from the first fiber end 12 to the second fiber end 14. Each of the plurality of fourth nested capillaries 81 includes an end (not shown) disposed proximate the first cladding end 24 and can at least partially define the first fiber end 12. Each of the fourth nested capillaries 81 includes another end (not shown) disposed proximate the second cladding end 26 and can at least partially define the second fiber end 14.

Each of the plurality of fourth nested capillaries 81 is disposed within the second nested interior 94 of a different one of the second nested capillaries 82. Each of the fourth nested capillaries 81 includes a fourth capillary axis 99. The fourth capillary axis 99 is parallel to the fiber longitudinal axis 16, the primary longitudinal axis 46, and the second capillary axis 88. Each of the fourth nested capillaries 81 includes a fourth nested inner surface 89 at a fourth nested inner radius 91 from the fourth capillary axis 99. The fourth nested inner surface 89 defines a fourth nested interior 97.

Each of the fourth nested capillaries 81 further includes a fourth nested outer surface 93 at a fourth nested outer radius 95 from the fourth capillary axis 99. In embodiments, the fourth nested outer radius 95 is greater than or equal to 3 μm, or greater than or equal to 4 μm, or greater than or equal to 5 μm, or greater than or equal to 6 μm, or greater than or equal to 7 μm, or greater than or equal to 8 μm, or greater than or equal to 9 μm, or greater than or equal to 10 μm, or greater than or equal to 11 μm, or in the range from 3 μm to 15 μm, or in the range from 4 μm to 13 μm, or in the range from 5 μm to 11 μm, or in the range from 6 μm to 10 μm. The fourth nested outer radius 95 of the different ones of the fourth nested capillaries 81 may be the same or different. The fourth nested outer radius 95 of the different ones of the fourth nested capillaries 81 may be the same as or different from the third nested outer radius 79 of the third nested capillaries 61.

Each of the fourth nested capillaries 81 further includes a fourth nested thickness 101. The fourth nested thickness 101 is the distance measured radially from the fourth capillary axis 99 between the fourth nested inner surface 89 and the fourth nested outer surface 93. In embodiments, the fourth nested thickness 101 is within a range of from 250 nm to 1500 nm. For example, the fourth nested thickness 101 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 1150 nm to 1400 nm, and so on). In embodiments, the fourth nested thickness 101 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the fourth nested capillaries 81. The fourth nested thickness 101 of the different ones of the fourth nested capillaries 81 are the same or different. The fourth nested thickness 101 of the different ones of the fourth nested capillaries 81 are the same as or different from the third nested thickness 85 of the third nested capillaries 61.

FIG. 2E is an excerpt from FIG. 3A that shows the region in the vicinity of primary capillaries 20a and 20b. Depicted in FIG. 2E is a point P1 that represents a point of contact of primary capillary 20a and primary capillary 20b. Point P1 is adjacent to peak 40 of the cladding inner surface 30 shown in FIG. 2A. Also depicted in FIG. 2E are points P2 and P3. Point P2 represents a common point of contact of second nested capillary 82a and fourth nested capillary 81a of primary capillary 20a with the cladding inner surface 30. Point P3 represents a common point of contact of first nested capillary 66b and third nested capillary 61a of primary capillary 20b with the cladding inner surface 30. Points P2 and P3 are radially outward of point P1. By “radially outward” is meant further from the fiber longitudinal axis 16 in the radial direction. In embodiments with plateaus 39, the points of contact P2 and P3 may be radially inward of plateaus 39 (adjacent to air pockets 71) or radially outward of plateaus 39.

FIG. 2F illustrates anti-resonant cladding elements with various configurations of the nested capillaries. Each configuration shows as a representative example primary capillary 20a with second nested capillary 82a and fourth nested capillary 81a relative to fiber longitudinal axis 16. The point P1 at which primary capillary 20a contacts primary capillary 20b is also depicted. Configuration (I) reproduces the configuration shown in FIG. 2E. In configuration (I), second nested capillary 82a and fourth nested capillary 81a are in contact at a common point P2 with the primary inner surface 50 of the of primary capillary 20a and the cladding inner surface 30 of the cladding tube 18. In configuration (I), the point of contact of second nested capillary 82a and fourth nested capillary 81a is aligned with the point of contact of second nested capillary 82a and primary capillary 20a in a radial direction from the fiber longitudinal axis 16. In other embodiments, the point of contact of fourth nested capillary 81a with second nested capillary 82a differs from the point of contact of second nested capillary 82a with primary capillary 20a and the cladding inner surface 30. Configuration (II) shows an embodiment in which fourth nested capillary 81a contacts second nested capillary 82a at a point P2′ that is radially inward of point P2. Configuration (III) shows an embodiment in which fourth nested capillary 81a contacts second nested capillary 82a at a point P2″ that is radially outward of point P2.

The dimensions and positioning of the primary and nested capillaries in the disclosed anti-resonant cladding elements are designed to minimize confinement loss of the fundamental mode and to suppress higher order modes of electromagnetic radiation 23 propagating in anti-resonant hollow core optical fiber 10. The greater the confinement loss of higher order modes, the better the signal quality of the fundamental mode.

The designs also minimize coupling of the fundamental mode to dielectric modes supported by the anti-resonant cladding elements despite contact of primary capillaries. Coupling of the fundamental mode to dielectric cladding modes is undesirable because it leads to sharp, high-loss peaks in the confinement loss spectrum of the anti-resonant hollow core optical fiber 10. The prevailing view in the art has been that elimination of the sharp high-loss peaks in the confinement loss spectrum requires a lack of contact between the primary capillaries of the anti-resonant cladding elements. The designs disclosed herein, however, are able to minimize coupling of the fundamental mode with dielectric cladding modes even though adjacent primary capillaries are in contact. Contact of the primary capillaries is expected to improve the stability of the internal structure of the anti-resonant hollow core optical fiber during the draw process.

In embodiments, the anti-resonant hollow core optical fiber 10 exhibits a confinement loss for the fundamental mode of electromagnetic radiation 23, throughout an entirety of a wavelength range of from 1500 nm to 1600 nm, that is less than or equal to 0.50 dB/km. For example, the confinement loss that the anti-resonant hollow core optical fiber 10 exhibits for the fundamental mode of electromagnetic radiation 23 at each wavelength in the wavelength range from 1500 nm to 1600 nm is less than or equal to 0.50 dB/km, or less than or equal to 0.40 dB/km, or less than or equal to 0.30 dB/km, or less than or equal to 0.20 dB/km, or less than or equal to 0.15 dB/km, or less than or equal to 0.10 dB/km, or less than or equal to 0.05 dB/km, or less than or equal to 0.03 dB/km, or less than or equal to 0.01 dB/km, or in a range from 0.005 dB/km to 0.50 dB/km, or in a range from 0.005 dB/km to 0.40 dB/km, or in a range from 0.005 dB/km to 0.30 dB/km, or in a range from 0.005 dB/km to 0.20 dB/km, or in a range from 0.005 dB/km to 0.10 dB/km, or in a range from 0.01 dB/km to 0.50 dB/km, or in a range from 0.01 dB/km to 0.40 dB/km, or in a range from 0.01 dB/km to 0.30 dB/km, or in a range from 0.01 dB/km to 0.20 dB/km, or in a range from 0.01 dB/km to 0.10 dB/km, or in a range from 0.03 dB/km to 0.50 dB/km, or in a range from 0.03 dB/km to 0.40 dB/km, or in a range from 0.03 dB/km to 0.30 dB/km, or in a range from 0.03 dB/km to 0.20 dB/km, or in a range from 0.03 dB/km to 0.10 dB/km, or in a range from 0.05 dB/km to 0.50 dB/km, or in a range from 0.05 dB/km to 0.40 dB/km, or in a range from 0.05 dB/km to 0.30 dB/km, or in a range from 0.05 dB/km to 0.20 dB/km, or in a range from 0.05 dB/km to 0.10 dB/km.

In embodiments, the anti-resonant hollow core optical fiber 10 exhibits a confinement loss for the fundamental mode of electromagnetic radiation 23, throughout an entirety of a wavelength range of from 1400 nm to 1600 nm, that is less than or equal to 0.50 dB/km. For example, the confinement loss that the anti-resonant hollow core optical fiber 10 exhibits for the fundamental mode of electromagnetic radiation 23 at each wavelength in the wavelength range from 1400 nm to 1600 nm is less than or equal to 0.50 dB/km, or less than or equal to 0.40 dB/km, or less than or equal to 0.30 dB/km, or less than or equal to 0.20 dB/km, or less than or equal to 0.15 dB/km, or less than or equal to 0.10 dB/km, or less than or equal to 0.05 dB/km, or less than or equal to 0.03 dB/km, or less than or equal to 0.01 dB/km, or in a range from 0.005 dB/km to 0.50 dB/km, or in a range from 0.005 dB/km to 0.40 dB/km, or in a range from 0.005 dB/km to 0.30 dB/km, or in a range from 0.005 dB/km to 0.20 dB/km, or in a range from 0.005 dB/km to 0.10 dB/km, or in a range from 0.01 dB/km to 0.50 dB/km, or in a range from 0.01 dB/km to 0.40 dB/km, or in a range from 0.01 dB/km to 0.30 dB/km, or in a range from 0.01 dB/km to 0.20 dB/km, or in a range from 0.01 dB/km to 0.10 dB/km, or in a range from 0.03 dB/km to 0.50 dB/km, or in a range from 0.03 dB/km to 0.40 dB/km, or in a range from 0.03 dB/km to 0.30 dB/km, or in a range from 0.03 dB/km to 0.20 dB/km, or in a range from 0.03 dB/km to 0.10 dB/km, or in a range from 0.05 dB/km to 0.50 dB/km, or in a range from 0.05 dB/km to 0.40 dB/km, or in a range from 0.05 dB/km to 0.30 dB/km, or in a range from 0.05 dB/km to 0.20 dB/km, or in a range from 0.05 dB/km to 0.10 dB/km

In embodiments, the anti-resonant hollow core optical fiber 10 exhibits a confinement loss for the higher order modes of electromagnetic radiation 23, throughout an entirety of a wavelength range of from 1500 nm to 1600 nm, that is greater than or equal to 0.50 dB/km. For example, the confinement loss that the anti-resonant hollow core optical fiber 10 exhibits for the higher order modes of electromagnetic radiation 23 at each wavelength in the wavelength range from 1500 nm to 1600 nm is greater than or equal to 0.50 dB/km, or greater than or equal to 1.0 dB/km, or greater than or equal to 5.0 dB/km, or greater than or equal to 10 dB/km, or greater than or equal to 25 dB/km, or greater than or equal to 50 dB/km, or greater than or equal to 100 dB/km, or greater than or equal to 500 dB/km, or greater than or equal to 1000 dB/km, or in a range from 0.50 dB/km to 10000 dB/km, or in a range from 0.50 dB/km to 5000 dB/km, or in a range from 0.50 dB/km to 1000 dB/km, or in a range from 1.0 dB/km to 500 dB/km, or in a range from 5.0 dB/km to 250 dB/km, or in a range from 7.5 dB/km to 200 dB/km, or in a range from 10 dB/km to 150 dB/km.

In embodiments, the anti-resonant hollow core optical fiber 10 exhibits a confinement loss for the higher order modes of electromagnetic radiation 23, throughout an entirety of a wavelength range of from 1400 nm to 1600 nm, that is greater than or equal to 0.50 dB/km. For example, the confinement loss that the anti-resonant hollow core optical fiber 10 exhibits for the higher order modes of electromagnetic radiation 23 at each wavelength in the wavelength range from 1400 nm to 1600 nm is greater than or equal to 0.50 dB/km, or greater than or equal to 1.0 dB/km, or greater than or equal to 5.0 dB/km, or greater than or equal to 10 dB/km, or greater than or equal to 25 dB/km, or greater than or equal to 50 dB/km, or greater than or equal to 100 dB/km, or greater than or equal to 500 dB/km, or greater than or equal to 1000 dB/km, or in a range from 0.50 dB/km to 10000 dB/km, or in a range from 0.50 dB/km to 5000 dB/km, or in a range from 0.50 dB/km to 1000 dB/km, or in a range from 1.0 dB/km to 500 dB/km, or in a range from 5.0 dB/km to 250 dB/km, or in a range from 7.5 dB/km to 200 dB/km, or in a range from 10 dB/km to 150 dB/km.

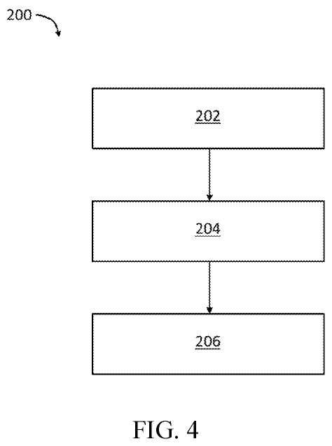

Referring now to FIGS. 4-8, a method 200 of manufacturing the anti-resonant hollow core optical fiber 10 is described herein. The method 200 includes at least a preform recess formation step 202, a primary preform capillary arrangement step 204, and a drawing step 206.

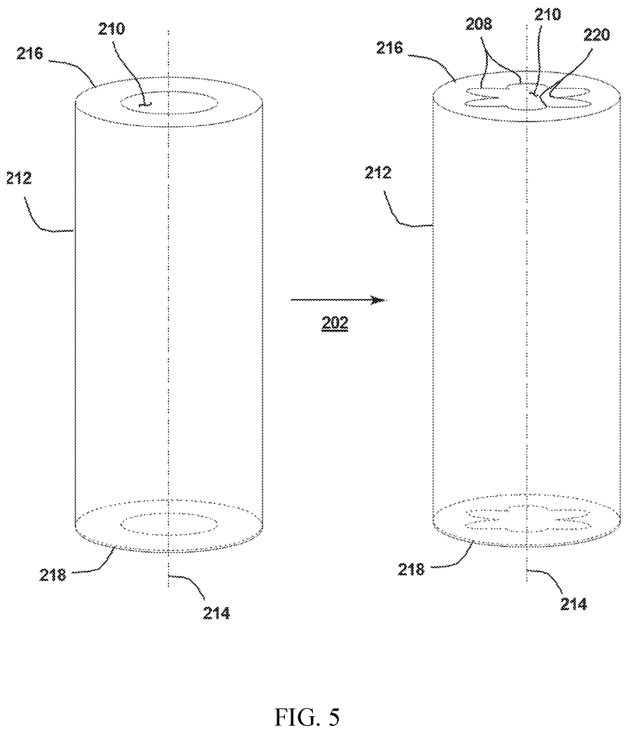

The preform recess formation step 202 (see FIG. 5) includes forming a plurality of preform recesses 208 within a cladding preform inner surface 210 of a cladding preform tube 212 through which a cladding preform longitudinal axis 214 extends. For example, the cladding preform inner surface 210 can initially be cylindrical. The plurality of recesses 208 can then be machined into the cladding preform inner surface 210. Each of the plurality of preform recesses 208 is disposed longitudinally from a first preform end 216 to a second preform end 218 of the cladding preform tube 212. In embodiments, each of the plurality of perform recesses 208 merges with an adjacent preform recess 208 in both azimuthal directions around the preform longitudinal axis so that the cladding preform inner surface 210 forms preform peaks 220 pointing inward toward the cladding preform longitudinal axis 214. In other embodiments, the cladding preform inner surface 201 forms plateaus (not separately illustrated) of constant radius from the cladding preform longitudinal axis 214 between adjacent preform recesses 208 in both azimuthal directions around the preform longitudinal axis 214.

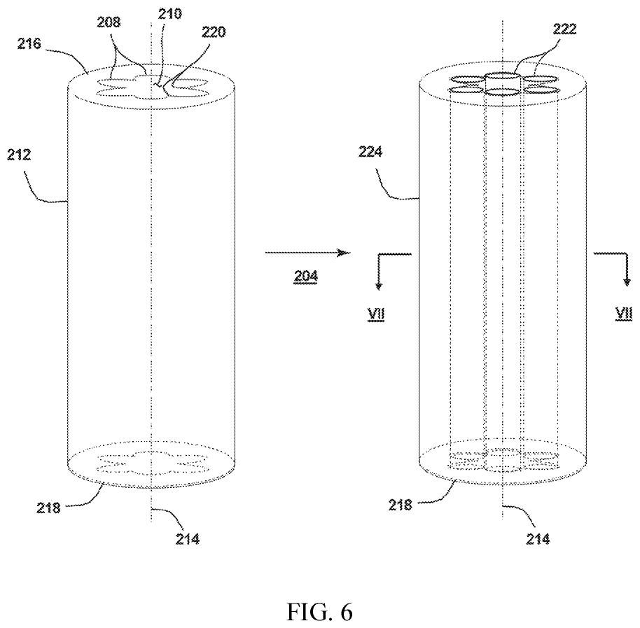

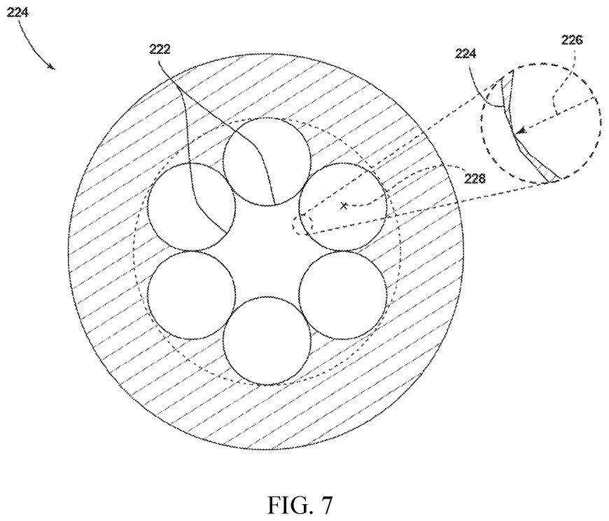

The primary preform capillary arrangement step 204 (see FIGS. 6-7) includes arranging a plurality of primary preform capillaries 222 within the plurality of preform recesses 208 of the cladding preform tube 212. For example, the plurality of primary preform capillaries 222 can be formed and fused (e.g., via flame treatment, laser treatment, among other ways) to the cladding preform inner surface 210 with the plurality of preform recesses 208. The coupling of the plurality of primary preform capillaries 222 to the cladding preform tube 212 forms an optical fiber preform 224. Nested preform capillaries (not separately illustrated) can be similarly formed and fused to the inner surface of the primary preform capillaries 222 either before or after coupling of the plurality of primary preform capillaries 222 to the cladding preform tube 212. Each of the plurality of primary preform capillaries 222 includes an outer primary preform surface 224 at an outer primary preform radius 226 from a primary capillary preform axis 228. The primary capillary preform axis 228 is parallel to the cladding preform longitudinal axis 214. Each of the plurality of primary preform capillaries 222 contacts an adjacent primary preform capillary 222 in both azimuthal directions around the cladding preform longitudinal axis 214. Each of the plurality of primary preform capillaries 222 contacts the cladding preform inner surface 210. The plurality of preform recesses 208 is dimensioned to substantially match the outer primary preform radius 226 of the plurality of primary preform capillaries 222.

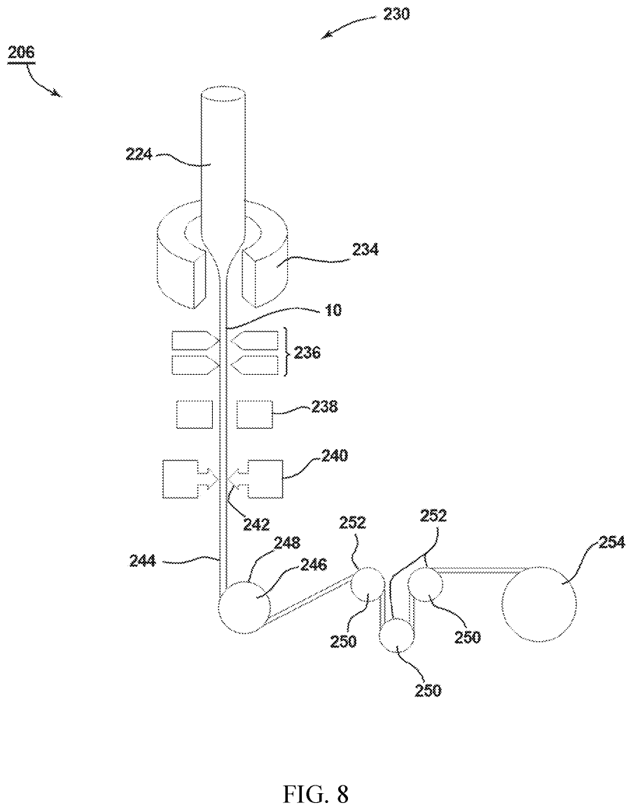

The drawing step 206 includes drawing the anti-resonant hollow core optical fiber 10 from the optical fiber preform 224. The drawing step 206 (see FIG. 8) can be performed using a draw system 230. The draw system 230 can include a furnace for heating the optical fiber preform 224 to melt or soften the cladding preform tube 212 and the plurality of primary preform capillaries 222. The furnace 232 can be disposed in a draw tower. In embodiments, the furnace 232 includes a heater 234 such that the optical fiber preform 224 is consumed and drawn into the anti-resonant hollow core optical fiber 10 as it is lowered towards the heater 234. The draw system 230 can further include non-contact measurement sensors 236 for measuring the size (e.g., cladding outer radius 32) of the anti-resonant hollow core optical fiber 10 that exits the furnace 232. A cooling station 238 can reside downstream of the measurement sensors 236 and is configured to cool the anti-resonant hollow core optical fiber 10. A coating station 240 can reside downstream of the cooling station 238. The coating station 240 is configured to deposit a protective coating material 242 onto the anti-resonant hollow core optical fiber 10 to form a coated anti-resonant hollow core optical fiber 244. A tensioner 246 resides downstream of the coating station 240. The tensioner 246 has a surface 248 that pulls (draws) the coated anti-resonant hollow core optical fiber 244. A set of guide wheels 250 with respective surfaces 252 resides downstream of the tensioner 246. The guide wheels 250 serve to guide the coated anti-resonant hollow core optical fiber 244 to a fiber take-up spool 254 to store the coated anti-resonant hollow core optical fiber 244.

The cladding tube 18, the plurality of primary capillaries 20, the plurality of first nested capillaries 66, the plurality of second nested capillaries 82, and further nested capillaries of the anti-resonant hollow core optical fiber 10 can all be made of or include silica. The silica of any of the cladding tube 18, the plurality of primary capillaries 20, the plurality of first nested capillaries 66, the plurality of second nested capillaries 82, and further nested capillaries can be doped with a viscosity-altering dopant (e.g., nitrogen, fluorine, alkali metals, alkaline earth metals, among other options) as desired to set conditions (e.g., melting point) to facilitate manufacturing (e.g., draw).

The anti-resonant hollow core optical fiber 10 and the method 200 of the present disclosure address the problems described in the Background, among others, in a variety of ways. For example, the anti-resonant hollow core optical fiber 10 exhibits relatively low confinement loss for the fundamental mode of the electromagnetic radiation 23 within and throughout the wavelength range from 1500 nm to 1600 nm, or the wavelength range from 1400 nm to 1600 nm. The low confinement loss within such wavelength ranges is desirable because 1550 nm is a common target operating wavelengths. The low confinement loss was surprising because the merging or contacting of the plurality of primary capillaries 20 constitutes nodes, which are generally understood in the prior art to increase confinement loss. Without wishing to be bound by theory, it is theorized that the presence of nodes induces coupling between the core mode and the dielectric modes within the primary capillaries 20, which themselves leak into the cladding tube 18. The designs described herein of the anti-resonant hollow core optical fiber 10 reduce that theorized phenomena by burying the leakage loss from the dielectric modes associated with the primary capillaries 20 within the cladding tube 18 via the plurality of recesses 38. However, the confinement loss of the fundamental mode through the joints of primary capillaries and the cladding of the anti-resonant hollow core optical fiber 10 can be reduced though proper designs of multiply nested capillaries. In addition, the multiply nested capillarity designs offer flexibility in increasing the confinement loss for the higher order modes, which is beneficial for achieving single mode operations in an antiresonant hollow core optical fiber.

As mentioned above, manufacture of the anti-resonant hollow core optical fiber 10 is difficult and variances in relative positioning of the primary capillaries 20 and nested capillaries can occur. Especially, two primary capillaries can contact each other forming a node, which would normally cause sharp high-loss peaks in confinement loss for the fundamental mode as a function of wavelength. Such peaks, however, are not observed for the anti-resonant hollow core optical fibers 10 disclosed herein.

Further and related, the design intention that adjacent primary capillaries 20 contact or merge eases manufacturing. Typically, the anti-resonance depends on adjacent primary capillaries 20 not contacting or merging, with an air gap separating them. However, this is difficult to achieve in practice, because as the preform enters the draw furnace 232, gas pressure within the primary capillaries 20 increases, which causes the primary capillaries 20 to expand, which can result in them contacting each other, before the gas pressure decreases and the primary capillaries 20 deflate. That is no longer an issue because adjacent primary capillaries 20 of the anti-resonant hollow core optical fiber 10 are designed to contact or merge.

Moreover, typically, the anti-resonance depends on the plurality of primary capillaries 20 maintaining a precise angle of attachment to the cladding inner surface 30. Manufacture can result in angular variations or rotations along the length of the optical fiber. However, with the plurality of recesses 38 cradling the plurality of primary capillaries 20, angular variation and rotation is much less likely to occur during the drawing step 206.

### EXAMPLE

A representative example of an anti-resonant hollow core optical fiber in accordance with the present disclosure is now described. In the fiber design, (a) the anti-resonant cladding elements were equally spaced in the azimuthal direction about the longitudinal axis of the anti-resonant hollow core optical fiber, (b) each primary capillary was in contact with an adjacent primary capillary in each azimuthal direction (clockwise and counterclockwise) about the longitudinal axis of the anti-resonant hollow core optical fiber, (c) all nested capillaries were in contact along a common radial line extending from the center of the hollow core to the point of contact of the primary capillary with the inside surface of the cladding tube, and (d) the cladding tube occupied an entirety of the primary capillary region, outside of the primary capillaries, that was radially inward of the capillary region radius and radially outward of where adjacent primary capillaries contacted or merged. The confinement loss of the fundamental mode and higher order modes as a function of wavelength of electromagnetic radiation transmitted in the core region of each exemplary design was modeled using COMSOL Multiphysics® finite element software.

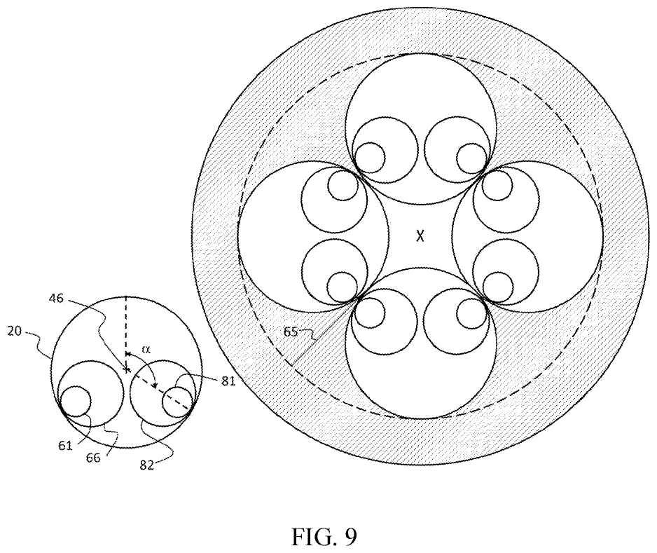

In this example, the anti-resonant hollow core optical fiber has the design shown in FIG. 9. The example fiber design includes four anti-resonant cladding elements of the type shown in FIG. 2C, which is reproduced in FIG. 9. Each anti-resonant cladding element included a primary capillary 20, a first nested capillary 66, a second nested capillary 82, a third nested capillary 61, and a fourth nested capillary 81. The dimensions of corresponding capillaries were the same for the four anti-resonant cladding elements and are given in Table 1. The thickness of all primary capillaries was 1250 nm and the thickness of all nested capillaries was 400 nm. The arrangement of nested capillaries in each anti-resonant cladding element was as shown in configuration (I) of FIG. 2F in which the first nested capillary 66 and the third nested capillary 61 had a common point of contact with the primary capillary 20 and the second nested capillary 82 and the fourth nested capillary 81 had a (different) common point of contact with the primary capillary 20. The alignment of each point of contact is defined by the angle α, which has a magnitude of 120° for the pair of nested capillaries consisting of first nested capillary 66 and the third nested capillary 61 and the pair of nested capillaries consisting of second nested capillary 82 and the fourth nested capillary 81 in each of the anti-resonant cladding elements.

TABLE 1

Core radius = 14.0 μm
Outer radius of primary capillary = 34.2 μm
Outer radius of first nested capillary = 15.0 μm
Outer radius of second nested capillary = 15.0 μm
Outer radius of third nested capillary = 7.0 μm
Outer radius of fourth nested capillary = 7.0 μm
Depth = 50.0 μm

The modeling software was used to determine the confinement loss (CL) as a function of wavelength of electromagnetic radiation transmitted through the anti-resonant hollow core optical fiber. The confinement loss was calculated assuming an overlap between the primary capillaries and cladding inner surface of 200 nm, an overlap between the first nested capillary and primary capillary of 200 nm, an overlap between the second nested capillary and primary capillary of 200 nm, an overlap between the third nested capillary and the first nested capillary of 200 nm, an overlap between the fourth nested capillary and the second nested capillary of 200 nm.

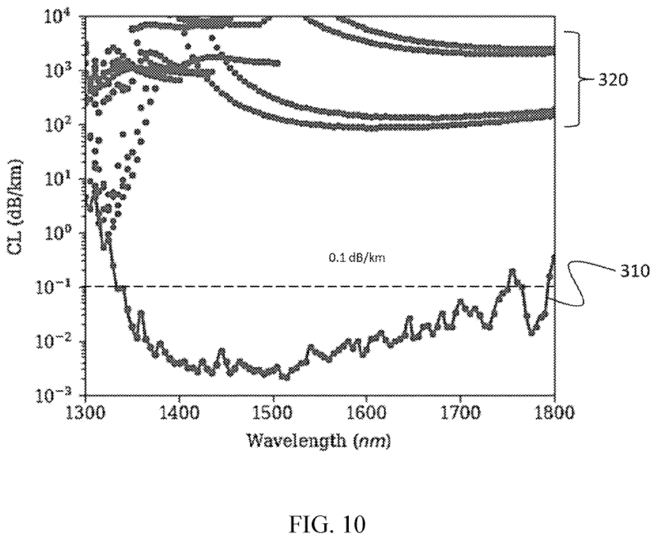

FIG. 10 shows the confinement loss (CL) as a function of wavelength of electromagnetic radiation over the wavelength range from 1300 nm to 1800 nm (1.3 μm to 1.8 μm) for the fundamental mode (FM) (Trace 310) and several higher order modes (HOM) (Trace 320) of the example fiber design. The confinement loss of the fundamental mode (FM) was less than 0.1 dB/km at each wavelength in the wavelength range from about 1330 nm to about 1750 nm and less than 0.01 dB/km at each wavelength in the wavelength range from about 1350 nm to about 1650 nm. The confinement loss of higher order modes (HOM) was greater than 0.1 dB/km at each wavelength in the wavelength range from 1300 nm to 1800 nm and was greater than 100 dB/km at each wavelength in the wavelength range from 1400 nm to 1800 nm. The high confinement loss of higher order modes (HOM) relative to the fundamental mode (FM) indicates suitability of the example fiber design for single mode operation.

It will be apparent to those skilled in the art that various modifications and variations can be made without departing from the spirit or scope of the claims.

What is claimed is:

1. An anti-resonant hollow core optical fiber comprising:
a fiber longitudinal axis extending from a first fiber end to a second fiber end;
a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis, wherein the cladding inner radius is azimuthally variable around the fiber longitudinal axis and the cladding inner surface defines a plurality of recesses;
a plurality of primary capillaries arranged azimuthally around the fiber longitudinal axis, each of the plurality of primary capillaries (a) disposed within a different one of the plurality of recesses and contacting the cladding inner surface, (b) contacting or merging with an adjacent primary capillary in both azimuthal directions around the fiber longitudinal axis, and (c) comprising (i) a primary longitudinal axis that is parallel to the fiber longitudinal axis, (ii) a primary outer surface at a primary outer radius from the primary longitudinal axis, and (iii) a primary inner surface at a primary inner radius from the primary longitudinal axis, the primary inner surface defining a primary interior;
a plurality of first nested capillaries extending longitudinally from the first fiber end to the second fiber end, each of the plurality of first nested capillaries (a) disposed within the primary interior of a different one of the plurality of primary capillaries and (b) comprising (i) a first capillary axis that is parallel to the fiber longitudinal axis and (ii) a first nested interior;
a plurality of second nested capillaries extending longitudinally from the first fiber end to the second fiber end, each of the plurality of second nested capillaries (a) disposed within the primary interior of a different one of the plurality of primary capillaries along with a different one of the plurality of first nested capillaries and (b) comprising (i) a second capillary axis that is parallel to the fiber longitudinal axis and (ii) a second nested interior;
a plurality of third nested capillaries extending longitudinally from the first fiber end to the second fiber end, each of the plurality of third nested capillaries (a) disposed within the first nested interior of a different one of the plurality of first nested capillaries and (b) comprising (i) a third capillary axis that is parallel to the fiber longitudinal axis and (ii) a third nested interior; and
an effective core region tangential to the plurality of primary capillaries at a core radius from the fiber longitudinal axis, the plurality of primary capillaries disposed radially outward of the effective core region.

2. The anti-resonant hollow core optical fiber of claim 1, wherein
each of the plurality of recesses merges with an adjacent recess in both azimuthal directions around the fiber longitudinal axis so that the cladding inner surface forms peaks pointing inward toward the fiber longitudinal axis.

3. The anti-resonant hollow core optical fiber of claim 1, wherein
the cladding inner surface further defines plateaus where the cladding inner radius is constant azimuthally around the fiber longitudinal axis, and
each of the plurality of recesses are separated from an adjacent recess in both azimuthal directions around the fiber longitudinal axis by a different one of the plateaus.

4. The anti-resonant hollow core optical fiber of claim 1, wherein
the primary outer radius of each of the plurality of primary capillaries is within a range of from 20 μm to 90 μm.

5. The anti-resonant hollow core optical fiber of claim 1, wherein
each of the plurality of primary capillaries further comprises a primary thickness that is within a range of from 250 nm to 1500 nm.

6. The anti-resonant hollow core optical fiber of claim 1, wherein
the cladding tube has from 3 to 9 recesses,
the anti-resonant hollow core optical fiber has from 3 to 9 primary capillaries, and the quantity of recesses and the quantity of primary capillaries are the same.

7. The anti-resonant hollow core optical fiber of claim 1, wherein
the core radius is within a range of from 5 μm to 100 μm.

8. The anti-resonant hollow core optical fiber of claim 1, wherein
each of the plurality of first nested capillaries further comprises a first nested outer radius from the first capillary axis that is within a range of from 5 μm to 30 μm.

9. The anti-resonant hollow core optical fiber of claim 1, wherein
each of the plurality of first nested capillaries further comprises a first nested thickness that is within a range of from 250 nm to 1500 nm.

10. The anti-resonant hollow core optical fiber of claim 1, wherein
each of the plurality of second nested capillaries further comprises a second nested outer radius from the second capillary axis that is within a range of from 5 μm to 30 μm.

11. The anti-resonant hollow core optical fiber of claim 1, wherein
each of the plurality of second nested capillaries further comprises a second nested thickness that is within a range of from 250 nm to 1500 nm.

12. The anti-resonant hollow core optical fiber of claim 1, wherein
each of the plurality of third nested capillaries further comprises a third nested outer radius from the third capillary axis that is within a range of from 3 μm to 15 μm.

13. The anti-resonant hollow core optical fiber of claim 1, wherein
each of the plurality of third nested capillaries further comprises a third nested thickness that is within a range of from 250 nm to 1500 nm.

14. The anti-resonant hollow core optical fiber of claim 1, further comprising:
a plurality of fourth nested capillaries extending longitudinally from the first fiber end to the second fiber end, each of the plurality of fourth nested capillaries (a) disposed within the second nested interior of a different one of the plurality of second nested capillaries and (b) comprising (i) a fourth capillary axis that is parallel to the fiber longitudinal axis and (ii) a fourth nested interior.

15. The anti-resonant hollow core optical fiber of claim 1, wherein the primary capillary contacts an adjacent one of the plurality of primary capillaries at a contact point and the first nested capillary contacts the primary inner surface at a point radially outward of the contact point.

16. The anti-resonant hollow core optical fiber of claim 15, wherein the second nested capillary contacts the primary inner surface at a point radially outward of the contact point.

17. A method of manufacturing a preform for an anti-resonant hollow core optical fiber comprising:
a preform recess formation step comprising forming a plurality of preform recesses into a cladding preform inner surface of a cladding preform tube through which a cladding preform longitudinal axis extends, each of the plurality of preform recesses disposed longitudinally from a first preform end to a second preform end of the cladding preform tube;
a primary preform capillary arrangement step comprising arranging a plurality of primary preform capillaries within the plurality of preform recesses of the cladding preform tube, each of the plurality of primary preform capillaries (i) comprising an outer primary preform surface at an outer primary preform radius from a primary capillary preform axis parallel to the cladding preform longitudinal axis, (ii) contacting an adjacent primary preform capillary in both azimuthal directions around the cladding preform longitudinal axis, and (iii) contacting the cladding preform inner surface, wherein, the plurality of preform recesses is dimensioned to substantially match the outer primary preform radius of the plurality of primary preform capillaries;
a first nested preform capillary arrangement step comprising arranging a plurality of first nested preform capillaries in the plurality of primary preform capillaries, each of the plurality of primary preform capillaries including one of the plurality of first nested preform capillaries; and
a second nested preform capillary arrangement step comprising arranging a plurality of second nested preform capillaries in the plurality of primary preform capillaries, each of the plurality of primary preform capillaries including one of the plurality of first nested preform capillaries and one of the plurality of second nested preform capillaries.

18. The method of claim 17, wherein
each of the plurality of preform recesses merge with an adjacent preform recess in both azimuthal directions around the preform longitudinal axis so that the cladding preform inner surface forms peaks pointing inward toward the cladding preform longitudinal axis.

19. The method of claim 17, wherein
the cladding preform inner surface forms plateaus of constant radius from the cladding preform longitudinal axis between adjacent preform recesses in both azimuthal directions around the preform longitudinal axis.

20. The method of claim 17, further comprising
a third nested preform capillary arrangement step comprising arranging a plurality of third nested preform capillaries in the plurality of first nested preform capillaries, each of the plurality of first nested preform capillaries including one of the plurality of third nested preform capillaries.
